(19) United States
(12) Patent Application Publication
(10) Pub. No.: US 2026/0063447 A1
(43) Pub. Date: Mar. 5, 2026

(54) INDUCTIVE POSITION MEASURING DEVICE AND METHOD FOR OPERATING AN INDUCTIVE POSITION MEASURING DEVICE

(71) Applicant: DR. JOHANNES HEIDENHAIN GmbH, Traunreut (DE)

(72) Inventors: Matthias ECKART, Anger (DE); Christoph HEINEMANN, Übersee (DE); Marc Oliver TIEMANN, Tettenhausen (DE)

(21) Appl. No.: 19/307,397

(22) Filed: Aug. 22, 2025

(30) Foreign Application Priority Data
Aug. 29, 2024 (EP) 24197209.0

(51) Int. Cl. G01D 5/20

(52) U.S. Cl. CPC G01D 5/20

(57) ABSTRACT

An inductive position measuring device includes a first assembly having a first interaction surface and a second assembly having a second interaction surface. The two assemblies are arranged opposite each other in a third measurement direction and are movable relative to each other. The first assembly includes multiple first field interaction devices arranged parallel to the first interaction surface. The second assembly includes multiple second field interaction devices arranged in a flat manner distributed over the second interaction surface. At least one first field interaction device is arranged along a first measurement direction, at least one further first field interaction device is arranged along a second measurement direction, and each first field interaction device includes at least one excitation device and at least one receiver.

### CROSS-REFERENCE TO RELATED APPLICATIONS

The present application claims priority to Application No. 24197209.0, filed in the European Patent Office on Aug. 29, 2024, which is expressly incorporated herein in its entirety by reference thereto.

### FIELD OF THE INVENTION

The present invention relates to an inductive position measuring device and to a method for operating an inductive position measuring device.

### BACKGROUND INFORMATION

A movement device having a stationary assembly, a movable assembly, and a position determination system is described in PCT Patent Document No. WO 2020/088869. Both assemblies have their own power supply and include multiple circularly configured coils or capacitor plates that interact electromagnetically with each other.

A disadvantage is that both the movable and stationary assemblies use electrical components that must be connected to active electronics. This means that each assembly requires its own power supply and data connection, which leads to a significantly more complex configuration, particularly for stationary assemblies.

### SUMMARY

Example embodiments of the present invention provide an inductive position measuring device, in which the position of a movable assembly can be determined in multiple degrees of freedom and which is also inexpensive to produce.

According to example embodiments, an inductive position measuring includes a first assembly with a first interaction surface and a second assembly with a second interaction surface. The two assemblies are arranged opposite each other in a third measurement direction and are movable relative to each other. The second interaction surface is larger than the first interaction surface. The first assembly includes multiple first field interaction devices arranged parallel to the first interaction surface. The second assembly includes multiple second field interaction device, which are arranged in a flat manner distributed over the second interaction surface. The first and second field interaction devices can be brought into electromagnetic interaction. At least one first field interaction device is arranged along a first measurement direction, at least one second field interaction device is arranged along a second measurement direction, and the first field interaction devices include at least one field generation device configured to generate an electromagnetic field and at least one receiver configured to receive an electromagnetic field.

According to example embodiments, the first field interaction devices are arranged as elongated linear sensors, and the first and second measurement directions are perpendicular to each other.

An elongated linear sensor is, for example, a sensor that is configured to generate an electrical signal depending on its relative position with respect to one of the measurement directions and its distance from the second assembly. The linear sensor is structurally configured such that its dimension along the measurement direction to which it is arranged in parallel is greater than its other dimensions.

According to example embodiments, each of the first field interaction devices includes: a first receiver and a second receiver, which have a periodic curve with a constant period length, in which the receivers are arranged in the first or second measurement direction offset from each other by a quarter of their period length; and an excitation device, which surrounds the two receivers, e.g., in the form of a quadrilateral.

For example, the first assembly includes four first field interaction devices arranged in the first interaction surface and arranged perpendicular to each other.

In a configuration in which four first field interaction devices are provided, the receivers of the four first field interaction devices may be configured such that their peak-to-peak amplitude corresponds to at least one period length.

Alternatively, the first assembly includes eight first field interaction devices arranged in the first interaction surface and in pairs parallel to field interaction pairs, and the four field interaction pairs are arranged perpendicular to each other.

The perpendicular arrangement of the four field interaction device or the four field interaction pairs is such that each field interaction device or field interaction pair is perpendicular to exactly two adjacent field interaction devices or field interaction pairs, i.e., a square arrangement is formed by the field interaction devices or field interaction pairs.

In a configuration having eight field interaction devices or four field interaction pairs, the first receivers of at least one of the field interaction pairs may be configured identically and connected in series. In addition, the second receivers of at least one of the field interaction pairs are configured identically and connected in series. The peak-to-peak amplitude of at least one of the receivers is less than half the period length, and the distance between the two first receivers or the two second receivers within at least one field interaction pair is half the period length.

The foregoing refers to the distance within a field interaction pair that is located between the receiver of one first field interaction device and the receiver of the further first field interaction device with respect to the virtual zero crossings.

For example, in each of the four field interaction pairs, the first receivers are configured identically and the first receivers within a field interaction pair are connected in series. In the same manner, in each of the four field interaction pairs, the second receivers are, for example, configured identically and the first receivers within a field interaction pair are connected in series.

For example, it may be provided that the second assembly is not connected to an active power supply device and data processing device.

Thus, only the first assembly is connected to an active power supply device and data processing device.

For example, the second field interaction devices are arranged as quadrangular, e.g., square, areas, are of equal size, and are arranged in a grid-like manner evenly distributed on the second interaction surface.

For example, the second field interaction devices are produced using planar technology, e.g., by a thick film technique and, additionally or alternatively, a thin film technique.

In a method for operating an inductive position measuring device as described herein, using at least one first field interaction device, a predetermined excitation signal is transmitted to the second assembly, and a received signal present at at least one first field interaction device is measured separately. Via appropriate signal evaluation of at least one received signal, linear position information and, additionally or alternatively, distance information of the at least one first field interaction device with respect to the second assembly is determined.

For example, the predetermined excitation signal is modulated by at least one second field interaction device before it is measured as a received signal by at least one receiver.

The excitation signal is generated, for example, by that excitation device and the received signal is, for example, received by that receiver, which belong to one and the same field interaction pair and, for example, to one and the same first field interaction device.

For example, the modulation is performed depending on the position of the at least one second field interaction device on the second interaction surface.

For example, the inductive position measuring device determines the relative position of the first and second assemblies in at least four degrees of freedom, e.g., in six degrees of freedom.

The six degrees of freedom are, for example, six spatial degrees of freedom, e.g., three Cartesian position coordinates and three Euler angles.

For example, at least one first quality parameter is derived or determined from the position information and, additionally or alternatively, from the distance information of the first field interaction device, which determines a position information or distance information with respect to an identical measurement direction.

In addition, it is provided that at least one rotation information about an axis oriented in one of the measurement directions is determined from the position information and, additionally or alternatively, the distance information of at least two first field interaction devices or two field interaction pairs.

For example, at least one second quality parameter is derived or determined from the at least one rotation information.

According to example embodiments, an error signal is output depending on a first quality parameter and, additionally or alternatively, depending on a second quality parameter, and an optimization procedure is additionally or alternatively performed.

An error signal can be output or an optimization procedure can be initiated, for example, if a predefined limit value is exceeded.

Further features and aspects of example embodiments of the present invention are explained in more detail below with reference to the appended schematic Figures.

### BRIEF DESCRIPTION OF THE DRAWINGS

FIG. 1 is a perspective view of an inductive position measuring device including a first assembly and a second assembly.

FIG. 2 is a top view of the second assembly.

FIG. 3 is a top view of a first field interaction device.

FIG. 4 is a top view of a first field interaction device.

FIG. 5 illustrates a first interaction surface of a first assembly.

FIGS. 6a and 6b are top views of an inductive position measuring device, in which a relative rotation of a first assembly about the coordinate axis of the third measurement direction is illustrated.

FIG. 7 is a cross-sectional view through an inductive position measuring device, in which excitation and received signals are schematically illustrated.

### DETAILED DESCRIPTION

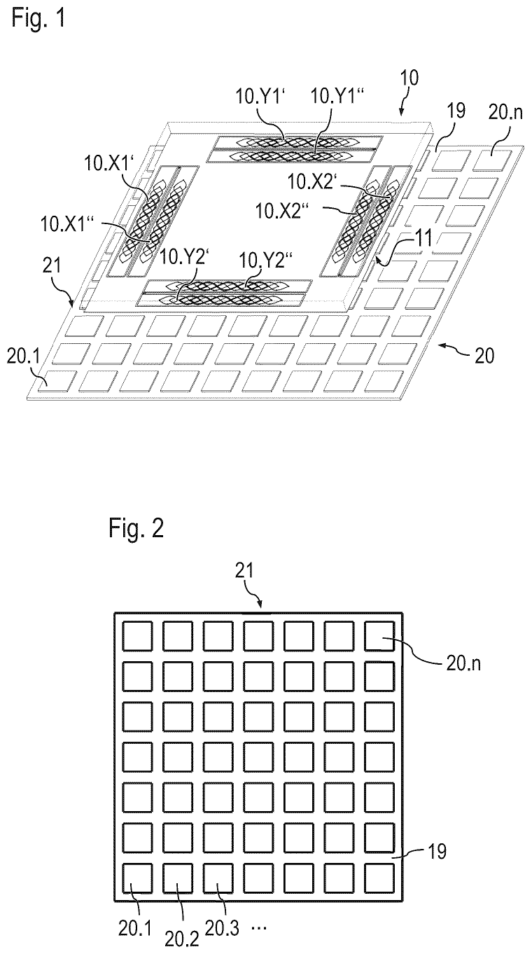

As illustrated in FIG. 1, an inductive position measuring device 1 includes a first assembly 10 and a second assembly 20, which are arranged opposite each other in a third measurement direction z and which are movable relative to each other. The first assembly 10 and the second assembly 20 are arranged at a distance from each other, so that an air gap is located between the two assemblies 10, 20.

The first assembly 10 includes a first interaction surface 11 having multiple first field interaction devices 10.X1′, 10.X1″, 10.X2′, 10.X2″, 10.Y1′, 10.Y1″, 10.Y2′, 10.Y2″, in which the first field interaction devices 10.X1′, 10.X1″, 10.X2′, 10.X2″, 10.Y1′, 10.Y1″, 10.Y2′, 10.Y2″ are arranged parallel to and flush within the first interaction surface 11. The first module 10 is supplied with electrical energy to generate at least one excitation signal S1 and to receive at least one received signal S2. This can be done via a cable or wirelessly, for example. The energy source may, for example, be a battery within the first assembly 10 or may be located outside the first assembly 10.

The second assembly 20 includes a second interaction surface 21 with multiple second field interaction devices 20.1 to 20.n. The second field interaction devices 20.1 to 20.n are arranged on or flush within the second interaction surface 21 and are distributed over its surface. The second module 20 does not independently form its own magnetic field and is also not actively supplied with electrical energy via cables, etc., as the second module 20 interacts purely passively with the first module 10.

The second interaction surface 21 of the second assembly 20 is generally configured to be larger than the first interaction surface 11 of the first assembly 10, so that there is always sufficient overlap between the two assemblies 10, 20, even when the first assembly 10 is positioned in the edge area of the second assembly 20.

The two interaction surfaces 11, 21 are arranged opposite each other and are spaced apart such that position determination is possible by electro-magnetic interaction between the first and second field interaction devices 10.X1′, 10.X1″, 10.X2′, 10.X2″, 10.Y1′, 10.Y1″, 10.Y2′, 10.Y2″ and 20.1 to 20.n. For example, this is the case in the condition that the first and second field interaction devices 10.X1′, 10.X1″, 10.X2′, 10.X2″, 10.Y1′, 10.Y1″, 10.Y2′, 10.Y2″ or 20.1 to 20.n at least partially overlap in the third measurement direction z viewed from above.

During operation of the inductive position measuring device 1, the position and orientation of the assemblies 10, 20 relative to each other can change in the three measurement directions x, y, z. For example, the three measurement directions x, y, z are orthogonal to each other. Through the electromagnetic interaction of the first field interaction devices 10.X1′, 10.X1″, 10.X2′, 10.X2″, 10.Y1′, 10.Y1″, 10.Y2′, 10.Y2″ with the second field interaction devices 20.1 to 20.n, the current position and orientation in six degrees of freedom is determined and evaluated by the inductive position measuring device 1. An evaluation device may be provided inside or outside the first assembly 10 for evaluating the position and orientation of the first assembly 10. Data can be transmitted, for example, by cable or alternatively wirelessly.

For example, one of the assemblies is immobile and stationary, whereas the other assembly is freely movable. For example, the second interaction surface 21 of the second assembly 20 may be multiple times larger than the first interaction surface 11 of the first assembly 10, in which case the second assembly 20 may be arranged as immobile and stationary. Alternatively, however, the first assembly 10 may also be arranged immobile and stationary, and the second assembly 20 may be movable relative to the first assembly 10. This is beneficial, for example, in the circumstance that it is not possible to supply the movable assembly with electrical energy.

FIG. 2 illustrates an arrangement of the second interaction surface 21 of the second assembly 20. The second interaction surface 21 may have any topography or be curved as appropriate, and it may be, for example, flat.

The second interaction surface 21 is, for example, the surface of a circuit board produced by a thin-film technique and, additionally or alternatively, a thick-film technique. The circuit board includes an electrically insulating base material 19, for example, a fiber-reinforced epoxy resin. An electrically conductive layer, e.g., made of copper, is applied to the base material 19 of the circuit board and is structured such that multiple second interaction devices 20.1 to 20.n are provided.

Alternatively, the individual second field interaction devices 20.1 to 20.n and the second interaction surface 21 may also be provided by a substrate. For example, this may be a metal substrate in which the individual second field interaction devices 20.1 to 20.n are provided in the form of elevations, in which no metal substrate is present between the individual second field interaction devices 20.1 to 20.n. The regions between the individual second field interaction devices 20.1 to 20.n may be arranged as empty space or an air gap or, for example, may be filled with an epoxy resin so that a flat surface is formed.

The second field interaction devices 20.1 to 20.n are arranged in the form of a square grid distributed over the second interaction surface 21 and have a defined distance from each other. The columns and rows of the second field interaction devices 20.1 to 20.n of the grid are arranged along the orthogonally-extending first and second measurement directions x, y. All second field interaction devices 20.1 to 20.n have identical dimensions, e.g., in the form of squares. However, other shapes are also possible, such as circles, rectangles, spirals, etc.

The grid may be completely filled with second field interaction devices 20.1 to 20.n, as illustrated in FIG. 2, so that the second field interaction devices 20.1 to 20.n are evenly distributed in a grid-like manner. Alternatively, the second field interaction devices 20.1 to 20.n may also be distributed unevenly over the second interaction surface 21, so that the grid includes individual locations or regions without second field interaction devices 20.1 to 20.n.

FIG. 3 illustrates a first exemplary arrangement of the first field interaction devices 10.X1, 10.X2, 10.Y1, 10.Y2. The first field interaction device 10.X1 is illustrated as an elongated linear sensor including a planar excitation device 10.1 configured to generate electromagnetic fields and two planar receivers 10.21, 10.22 configured to receive electromagnetic fields.

The first receiver 10.21 is arranged as a receiving conductive path and includes multiple conductive path sections. The basic curve of the first receiver 10.21 is structurally similar to a sinusoidal curve, in which the magnitude of the individual conducting path amplitudes is not necessarily structurally constant. Two adjacent conducting path amplitudes of the basic curve—including or consisting of a positive and a negative conducting path amplitude—have a period length T1 and a peak-to-peak amplitude SB1.

The first receiver 10.21 may be divided into a forward section and a return section. The forward section is similar in its basic curve to the graph of the function ƒ(x)=a·sin(x), with a∈ [symbol] ⁺. The return section is similar in its basic curve to the graph of the function g(x)=−a·sin(x), with a∈ [symbol] ⁺ This means that the return section of the first receiver 10.21 approximately corresponds to the forward section mirrored on a line of symmetry.

The second receiver 10.22 is configured in similar manner as the first receiver 10.21 as a receiving conductive path but is arranged offset by a quarter of the period length T1 relative to the first receiver 10.21 (offset V1). The offset V1 occurs, for example, along the first measurement direction x or along the second measurement direction y. The offset arrangement of the two receivers 10.21, 10.22 provides for correspondingly phase-shifted signals to be generated. The two receivers 10.21, 10.22 are electrically connected such that they supply a 0° signal and a 90° signal.

The two receivers 10.21, 10.22 differ in length from each other. For example, the first receiver 10.21 has a length of three periods, each with the period length T1, and the second receiver 10.22 has a length of two and a half periods, each with the period length T1.

The peak-to-peak amplitude SB1 for the receivers 10.21, 10.22 corresponds to the magnitude of the deflection between the minimum value and the maximum value within a period length T1. It is arranged perpendicular to the direction of the period length T1 or perpendicular to the first or the second measurement direction x, y.

According to the first exemplary arrangement of the first field interaction devices 10.X1, 10.X2, 10.Y1, 10.Y2, the peak-to-peak amplitudes SB1 of the first receivers 10.21 and the peak-to-peak amplitudes SB1 of the second receivers 10.22 are equal on average and correspond at least to the period length T1.

The receivers 10.21, 10.22 illustrated in FIG. 3 have peak-to-peak amplitudes SB1 that correspond to approximately 1.5 times the period length T1.

The two receivers 10.21, 10.22 are arranged as multiple conductive path sections in different layers of a carrier substrate. Details of such a multilayer structure including or consisting of conductive path sections are described in European Patent Document No. 4 530 851 and U.S. Patent Application Publication No. 2025/0109969, each of which is expressly incorporated herein in its entirety by reference thereto.

To compensate for yaw tilts, the receivers 10.21, 10.22 may, in some places, have additional loops S, S′, which are also formed from conductive path sections. For this purpose, the loops S, S′ are placed below the conductive path amplitudes at predetermined points along the basic curve. At points with the additional loops S, S′, the conducting path amplitudes of the receivers 10.21, 10.22 deviate from the basic curve and are shifted by a predetermined amount outwardly, i.e., in the direction of the excitation device 10.1. The loops S, S′ are slightly shifted inwardly with respect to the conducting path amplitudes of the basic curve, i.e., in the direction of the virtual zero crossing of the basic curve of the receivers 10.21, 10.22. However, a structurally deviating conducting path amplitude with a loop nevertheless results in an amplitude signal of identical magnitude to that of a normal conducting path amplitude without a loop.

The loops S, S′ are part of the receiving conductive path and are, for example, arranged on the first field interaction devices 10.X1, 10.X2, 10.Y1, 10.Y2 such that they are arranged mirror-symmetrically with respect to an axis A that divides the forward and return sections into equal parts.

The loops S of the first receiver 10.21 may be arranged either within the forward section and, additionally or alternatively, within the return section of the receiving conductive path.

The loops S′ of the second receiver 10.21 may also be arranged either within the forward section and, additionally or alternatively, within the return section of the receiving conductive path.

The two receivers 10.21, 10.22 are enclosed by the excitation device 10.1, i.e., surrounded on all sides. The excitation device 10.1 is arranged as an excitation conductive path and has a square or rectangular shape.

According to a second exemplary arrangement of the first field interaction devices 10.X1′, 10.X1″, 10.X2′, 10.X2″, 10.Y1′, 10.Y1″, 10.Y2′, 10.Y2″, they may also be arranged to form field interaction pairs 10.PX1, 10.PX2, 10.PY1, 10.PY2.

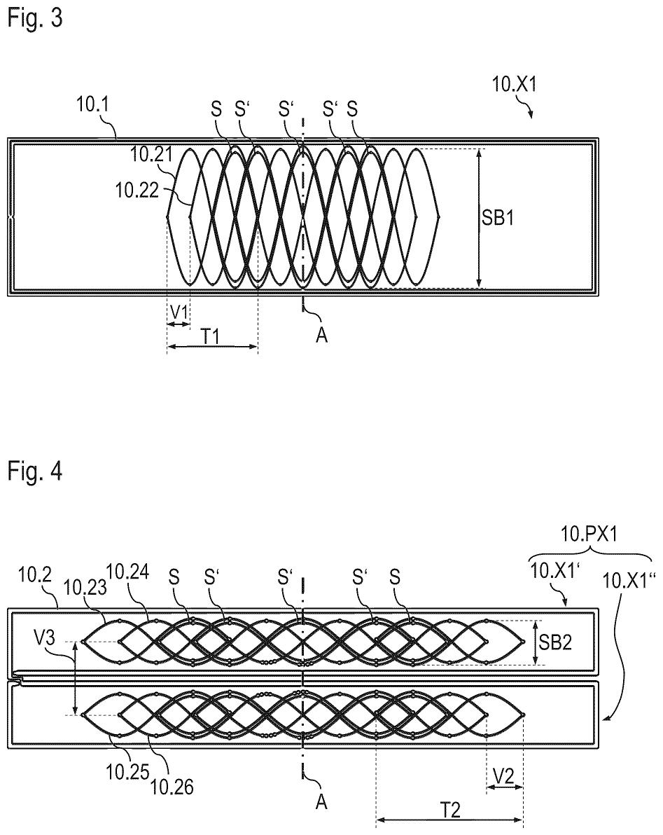

The field interaction pair 10.PX1 illustrated in FIG. 4 includes the first field interaction device 10.X1′ and the further first field interaction device 10.X1″. The two first field interaction devices 10.X1′, 10.X1″ are arranged as elongated linear sensors and together form a planar excitation device 10.2 (illustrated in FIG. 4) or, alternatively, a planar excitation device for generating electromagnetic fields.

The first field interaction device 10.X1′ includes a planar first receiver 10.23 and a planar second receiver 10.24 configured to receive electromagnetic fields. The further first field interaction device 10.X′ as well includes a planar first receiver 10.25 and a planar second receiver 10.26 configured to receive electromagnetic fields.

The first field interaction devices 10.X1′, 10.X1″ are arranged at a distance from each other so that an offset V3 is formed between the two first field interaction devices 10.X1′, 10.X1″ with respect to the receivers 10.23, 10.24 and the receivers 10.25, 10.26. The offset V3 is provided, for example, along the first measurement direction x or along the second measurement direction y. For example, the offset V3 corresponds to half a period length T2.

The configuration of the first field interaction devices 10.X1′, 10.X1″, 10.X2′, 10.X2″, 10.Y1′, 10.Y1″, 10.Y2′, 10.Y2″, according to the second exemplary arrangement, and their arrangement into field interaction pairs 10.PX1, 10.PX2, 10.PY1, 10.PY2, ensures that cross-sensitivity of the inductive measuring device 1 is reduced. For example, cross-sensitivity perpendicular to the measurement direction x or to the measurement direction y is reduced.

The first receivers 10.23, 10.25 are arranged as receiving conductive paths and are composed of multiple conductive path sections. The basic curve of the first receivers 10.23, 10.25 is similar to a sinusoidal curve, in which the magnitude of the individual conducting path amplitudes is not necessarily structurally constant. Two adjacent conducting path amplitudes of the basic curve—including or consisting of a positive and a negative conducting path amplitude—have a period length T2 and a peak-to-peak amplitude SB2.

The first receivers 10.23, 10.25 may be divided into a forward section and a return section. A forward section is similar in its basic curve to the graph of the function ƒ(x)=a·sin(x), with a∈ [symbol] ⁺. A return section is similar in its basic curve to the graph of the function g(x)=−a·sin(x), with a∈ [symbol] ⁺. This means that a return section of the first receivers 10.23, 10.25 approximately corresponds to a forward section mirrored on a line of symmetry.

The second receivers 10.24, 10.26 are configured similar to the first receivers 10.23, 10.25 as a receiving conductive path, but are arranged offset by a quarter of the period length T2 relative to the associated first receiver 10.23, 10.25 (offset V2). The offset V2 is provided, for example, along the first measurement direction x or along the second measurement direction y. The offset arrangement of the two receivers 10.23, 10.25 or 10.24, 10.26 provides for correspondingly phase-shifted signals to be generated. The two receivers 10.24, 10.26 or the two receivers 10.24, 10.26 are electrically connected such that they supply a 0° signal and a 90° signal.

The two receivers 10.23, 10.25 differ in length from each other. For example, the first receiver 10.23 has a length of three periods, each with the period length T2, and the second receiver 10.25 has a length of two and a half periods, each with the period length T2.

In a configuration of the first field interaction devices 10.X1′, 10.X1″, 10.X2′, 10.X2″, 10.Y1′, 10.Y1″, 10.Y2′, 10.Y2″, according to the second exemplary arrangement, the first receiver 10.23 of the first field interaction device 10.X1′ is connected in series with the first receiver 10.25 of the further first field interaction device 10.X1″. In addition, the second receiver 10.24 of the first field interaction device 10.X1′ is connected in series with the second receiver 10.26 of the further first field interaction device 10.X″. This serial connection results in a 0° signal and a 90° signal with increased signal amplitudes.

The peak-to-peak amplitude SB2 for the receivers 10.23, 10.25, 10.24, 10.26 corresponds to the magnitude of the deflection between the minimum value and the maximum value within a period length T2. It extends perpendicular to the direction of the period length T2 or perpendicular to the first or second measurement direction x, y.

According to the second exemplary arrangement of the first field interaction devices 10.X1′, 10.X1″, 10.X2′, 10.X2″, 10.Y1′, 10.Y1″, 10.Y2′, 10.Y2″, the peak-to-peak amplitudes SB2 of a first receiver 10.23, 10.25 and the peak-to-peak amplitudes SB2 of an associated second receiver 10.24, 10.26 are equal on average and correspond to at most half the period length T2.

The receivers 10.23, 10.25, 10.24, 10.26 illustrated in FIG. 3 have peak-to-peak amplitudes SB2 that correspond to approximately one third of the period length T2.

The first and second receivers 10.23, 10.25, 10.24, 10.26 are formed from multiple conductive path sections in different positions of a substrate.

To compensate for yaw tilts, the receivers 10.23, 10.25, 10.24, 10.26 may in some places have additional loops S, S′, which are formed from conductive path sections. For this purpose, the loops S, S′ are placed below the conductive path amplitudes at predetermined points along the basic curve. At points with the additional loops S, S′, the conducting path amplitudes of the receivers 10.21, 10.22 deviate from the basic curve and are shifted by a predetermined amount outwardly, i.e., in the direction of the excitation device 10.1. The loops S, S′ are slightly shifted inwardly with respect to the conducting path amplitudes of the basic curve, i.e., in the direction of the virtual zero crossing of the basic curve of the receivers 10.23, 10.25, 10.24, 10.26. However, in the case of a structurally different conducting path amplitude with a loop, the result is an amplitude signal that is identical in size to that of a normal conducting path amplitude without a loop.

The loops S, S′ are part of a receiving conductive path and are, for example, arranged on the two first field interaction devices 10.X1′, 10.X1″ such that they are arranged mirror-symmetrically with respect to an axis A, which divides a forward or return section into equal parts.

The loops S of the first receivers 10.23, 10.25 may be arranged either within a forward section, and additionally or alternatively, within a return section of the receiving conductive path.

The loops S′ of the second receivers 10.24, 10.26 may also be arranged either within a forward section and, additionally or alternatively, within a return section of the receiving conductive paths.

As explained above, the receivers 10.23, 10.25, 10.24, 10.26 are bounded by either a common excitation device 10.2 or by multiple separate excitation devices, i.e., surrounded on all sides. The excitation device 10.2 is arranged as an excitation conductive path and has a square or rectangular.

For example, one excitation device 10.2 can form two rectangles, e.g., one rectangle around the receivers 10.23, 10.24 and one rectangle around the receivers 10.25, 10.26, as illustrated in FIG. 4. Alternatively, two excitation devices may be provided, in which one excitation device forms a rectangle around the receivers 10.23, 10.24 and a further excitation device forms a rectangle around the receivers 10.25, 10.26.

The first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″ are arranged within the first interaction surface 11 of the first assembly 10. The first interaction surface 11 is the surface of a circuit board produced by a thin-film technique and, additionally or alternatively, by a thick-film technique. To configure the structured first field interaction devices 10.X1, 10.X1′, 10.X1″, 10.X2, 10.X2′, 10.X2″, 10.Y1, 10.Y1′, 10.Y1″, 10.Y2, 10.Y2′, 10.Y2″, multiple separate superimposed and electrically conductive layers may be provided that are separated from each other by insulating layers. At predefined points, referred to as vias, there is an electrical connection between the conductive paths of the various electrically conductive layers.

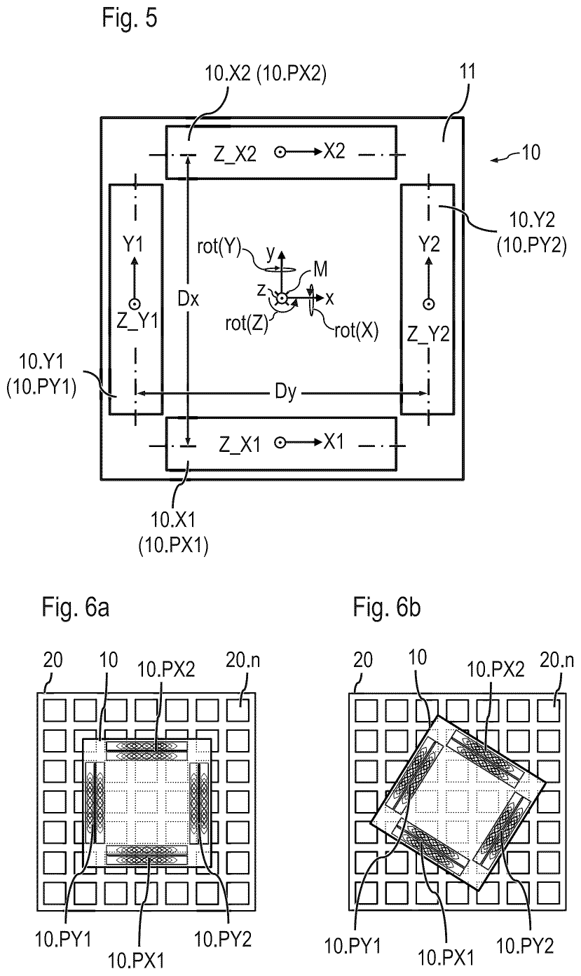

As illustrated in FIG. 5, the two first field interaction devices 10.X1, 10.X2 or the two field interaction pairs 10.PX1, 10.PX2 extend parallel to the first measurement direction x and are arranged at a distance Dx from each other. The two first field interaction devices 10.Y1, 10.Y2 or the two field interaction pairs 10.PY1, 10.PY2 extend parallel to the second measurement direction y and are also arranged at a distance Dy from each other. For example, the arrangement of the first field interaction devices 10.X1, 10.X2, 10.Y1, 10.Y2 and of the field interaction pairs 10.PX1, 10.PX2, 10.PY1, 10.PY2 corresponds to a quadrilateral arrangement, e.g., in the form of a square (Dx=Dy).

Via the two receivers 10.21, 10.22, 10.23, 10.24, 10.25, 10.26 of each first field interaction device 10.X1, 10.X2, 10.Y1, 10.Y2 or each field interaction pair 10.PX1, 10.PX2, 10.PY1, 10.PY2, in which the receivers are offset in the first measurement direction x or in the second measurement direction y, each field interaction device 10.X1, 10.X2, 10.Y1, 10.Y2 or each field interaction pair 10.PX1, 10.PX2, 10.PY1, 10.PY2 supplies two measured variables in the form of a 0° signal and a 90° signal, so that a total of eight measured variables may be used for position determination.

For each field interaction device 10.X1, 10.X2, 10.Y1, 10.Y2 or field interaction pair 10.PX1, 10.PX2, 10.PY1, 10.PY2, a linear position value X1, X2, Y1, Y2 in the corresponding measurement direction x, y and a signal amplitude are first determined from the 0° and 90° signals. The signal amplitude may be used to form a distance value Z_X1, Z_X2, Z_Y1, Z_Y2. The distance value Z_X1, Z_X2, Z_Y1, Z_Y2 of a first field interaction device 10.X1, 10.X2, 10.Y1, 10.Y2 or field interaction pair 10.PX1, 10.PX2, 10.PY1, 10.PY2 quantifies the distance of the corresponding field interaction device 10.X1, 10.X2, 10.Y1, 10.Y2 or field interaction pair 10.PX1, 10.PX2, 10.PY1, 10.PY2 to the second interaction surface 21 of the second assembly 20 in the third measurement direction z.

As illustrated in FIG. 5, the first field interaction device 10.X1 or the field interaction pair 10.PX1 provides the position value X1 for the first measurement direction x and the distance value Z_X1 for the third measurement direction z. Analogously, the first field interaction device 10.X2 or the field interaction pair 10.PX2 provides the position value X2 for the first measurement direction x and the distance value Z_X2 for the third measurement direction z, the first field interaction device 10.Y1 or the field interaction pair 10.PY1 provides the position value Y1 for the second measurement direction y and the distance value Z_Y1 for the third measurement direction z, and the first field interaction device 10.Y2 or the field interaction pair 10.PY2 provides the position value Y2 for the second measurement direction y and the distance value Z_Y2 for the third measurement direction z.

Consequently, during a measuring cycle, the inductive position measuring device 1 supplies two position values X1, X2 for the first measurement direction x, two position values Y1, Y2 for the second measurement direction y, and four distance values Z_X1, Z_X2, Z_Y1, Z_Y2 for the third measurement direction z.

In this manner, the relative position of the first assembly 10 with respect to the second assembly 20 can be determined in up to six degrees of freedom. In addition, a conclusion may be made about the reliability of the determined values by determining quality parameters and, if necessary, further measures can be initiated on the basis thereof.

The position of the center point M of the first assembly 10 may be determined, for example, by averaging the position values X1, X2; Y1, Y2 of two first field interaction devices 10.X1, 10.X2; 10.Y1, 10.Y2 or field interaction pairs 10.PX1, 10.PX2; 10.PY1, 10.PY2 extending in an identical measurement direction x, y:

$$\overline{X} = \frac{X 1 + X 2}{2} ,$$

in which X̅ represents the position value relative to the first measurement direction x of the center point M of the first assembly 10, and:

$$\overline{Y} = \frac{Y 1 + Y 2}{2} ,$$

in which Y̅ represents the position value relative to the second measurement direction y of the center point M of the first assembly 10.

The distance between the first assembly 10 and the second assembly 20 may be determined in a variety of manners, since each first field interaction device 10.X1, 10.X2, 10.Y1, 10.Y2 or field interaction pair 10.PX1, 10.PX2, 10.PY1, 10.PY2 provides at least one distance value Z_X1, Z_X2, Z_Y1, Z_Y2:

$$\overline{Z\_X} = \frac{Z\_X1 + Z\_X2}{2} ,$$

in which Z̅_̅X̅ represents the averaged distance value in the third measurement direction z, which originates from the first field interaction device 10.X1, 10.X2 or the field interaction pairs 10.PX1, 10.PX2 extending in the first measurement direction x, or

$$\overline{Z\_Y} = \frac{Z\_Y1 + Z\_Y2}{2} ,$$

in which Z̅_̅Y̅ represents the averaged distance value in the third measurement direction z, which originates from the first field interaction device 10.Y1, 10.Y2 or the field interaction pairs 10.PY1, 10.PY2 extending in the second measurement direction y.

The average value of the two averaged distance values Z̅_̅X̅, Z̅_̅Y̅ may be used as the output value for the average distance—i.e., the distance at the center point M—of the first assembly 10 relative to the second assembly 20:

$$\overline{Z} = \frac{\overline{Z\_X} + \overline{Z\_Y}}{2} ,$$

in which Z̅ represents the average distance at the center point M of the first assembly 10 relative to the second assembly 20.

A deviation between the two averaged distance values Z̅_̅X̅, Z̅_̅Y̅ may be used to make a conclusion about the quality of the measurement results in the third measurement direction z:

$$D\_Z = \overline{Z\_X} - \overline{Z\_Y} ,$$

in which D_Z represents a first quality parameter via which a conclusion may be made about the quality of the measurement results in the third measurement direction z.

FIGS. 6a and 6b are top views of the inductive position measuring device 1 in top view, in which, in the first assembly 10, only the first interaction surface 11 with multiple first field interaction device 10.X1′, 10.X1″, 10.X2′, 10.X2″, 10.Y1′, 10.Y1″, 10.Y2′, 10.Y2″ arranged in pairs is illustrated. The first and second assemblies 10, 20 are located opposite each other and are arranged in two parallel planes so that an air gap is formed between the first and second assemblies 10, 20. The first assembly 10 is illustrated in FIG. 6a in a first position. FIG. 6b illustrates the first assembly 10 as deflected and has having assumed a second position. During the transition from the first to the second position, the first assembly 10 has performed a relative rotation about the coordinate axis of the third measurement direction z. The second assembly 20 remains immobile and stationary. The inductive position measuring device 1 is configured to determine and evaluate one or more relative rotations of the first assembly 10 in the three measurement directions x, y, z.

In the determination of the relative position of the first assembly 10 with respect to the second assembly 20, a relative rotation about the coordinate axis in the first measurement direction x may be determined as follows, for example:

$$rot ( X ) = arcsin ( \frac{Z\_X2 - Z\_X1}{Dx} ) ,$$

in which rot(X) represents a rotation value about the coordinate axis of the first measurement direction x and Dx represents the distance between the two first field interaction devices 10.X1, 10.X2 or field interaction pairs 10.PX1, 10.PX2, which measure the linear position in the first measurement direction x.

In a similar manner, a relative rotation about the coordinate axis of the second measurement direction y may also be determined according to the relationship:

$$rot ( Y ) = arcsin ( \frac{Z\_Y1 - Z\_Y2}{Dy} ) ,$$

in which rot(Y) represents a rotation value about the coordinate axis of the first measurement direction y and Dy represents the distance between the two first field interaction devices 10.Y1, 10.Y2 or field interaction pairs 10.PY1, 10.PY2, which measure the linear position in the second measurement direction y.

The calculation of a rotation about the coordinate axis of the third measurement direction z may be performed either using the equation:

$$rot ( Z\_X ) = arcsin ( \frac{X 1 - X 2}{Dx} ) ,$$

in which rot(Z_X) represents a rotation value about the coordinate axis of the third measurement direction z based on the position values X1, X2 and Dx represents the distance between the two first field interaction devices 10.X1, 10.X2 or field interaction pairs 10.PX1, 10.PX2, which measure the linear position in the first measurement direction x, or, alternatively, using the equation:

$$rot ( Z\_Y ) = arcsin ( \frac{Y 2 - Y 1}{Dy} ) ,$$

in which rot(Z_Y) represents a rotation value about the coordinate axis of the third measurement direction z based on the position values Y1, Y2 and Dy quantifies the distance between the two first field interaction devices 10.Y1, 10.Y2 or field interaction pairs 10.PY1, 10.PY2, which measure the linear position in the second measurement direction y.

Since the independent rotation values rot(Z_X) are redundant, they may be used to determine the mean value of the rotation about the coordinate axis of the third measurement direction z according to the relationship:

$$\overline{rot ( Z )} = \frac{rot ( Z\_X ) + rot ( Z\_Y )}{2} ,$$

in which r̅o̅t̅(̅Z̅)̅ represents the mean value of the rotation about the coordinate axis of the third measurement direction z.

By calculating the difference between the two independent rotation values rot(Z_X), rot(Z_Y), a quality parameter D_rot(Z) may be determined, which may be used as a conclusion or information about the reliability of the measured values in the first and second measurement directions x, y, according to the relationship:

$$D\_rot ( Z ) = rot ( Z\_X ) - rot ( Z\_Y ) ,$$

in which D_rot(Z) represents a second quality parameter via which a conclusion may be made about the reliability of the rotation values in the third measurement direction z.

In addition to the position values X1, X2, Y1, Y2, the mean values X̅, Y̅Z̅, Z̅_̅X̅, Z̅_̅Y̅, r̅o̅t̅(̅Z̅)̅, the distance values Z_X1, Z_X2, Z_Y1, Z_Y2, and the rotation values rot(X), rot(Y), rot(Z_X), rot(Z_Y), the inductive position measuring device 1 thus also has the two quality parameters D_Z and D_rot(Z) available within a measuring cycle. The smaller the values of these quality parameters, the more accurate the measurement results of the inductive position measuring device 1 are, or, for example, the more reliable the position and distance values are.

The quality parameters D_Z and D_rot(Z) may be used, for example, to output an error signal in response to one of the quality parameters D_Z, D_rot(Z) exceeding a predefined threshold value. In addition, or as an alternative, exceeding a threshold value may trigger an optimization process that corrects the cross-sensitivity of the individual first field interaction devices 10.X1, 10.X2, 10.Y1, 10.Y2 or field interaction pairs 10.PX1, 10.PX2, 10.PY1, 10.PY2.

As illustrated schematically in FIGS. 6a and 6b, position determination is performed, for example, on the basis of those field interaction pairs 10.PX1, 10.PX2, 10.PY1, 10.PY2 in which a sufficiently strong coupling forms, i.e., for those field interaction pairs 10.PX1, 10.PX2, 10.PY1, 10.PY2 and second field interaction device 20.1 to 20.n, which at least partially overlap in a top view seen in the third measurement direction z. For example, the first field interaction devices 10.X1′, 10.X1″, 10.X2′, 10.X2″, 10.Y1′, 10.Y1″, 10.Y2′, 10.Y2″ are dimensioned larger than the second field interaction devices 20.1 to 20.n, so that multiple second field interaction devices 20.1 to 20.n are always overlapped by at least one first field interaction device 10.X1′, 10.X1″, 10.X2′, 10.X2″, 10.Y1′, 10.Y1″, 10.Y2′, 10.Y2″. For example, the receivers 10.23, 10.24, 10.25, 10.26 of the first field interaction devices 10.X1′, 10.X1″, 10.X2′, 10.X2″, 10.Y1′, 10.Y1″, 10.Y2′, 10.Y2″ overlap multiple second field interaction devices 20.1 to 20.n.

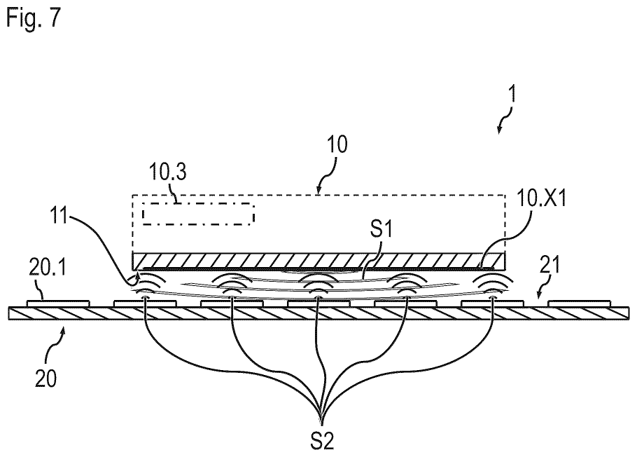

FIG. 7 is a cross-sectional view through the first and second assemblies 10, 20 of the inductive position measuring device 1.

The first assembly 10 includes evaluation electronics 10.3, which individually applies a predetermined excitation signal S1 to each individual field interaction device 10.X1, 10.X2, 10.Y1, 10.Y2 or each individual field interaction pair 10.PX1, 10.PX2, 10.PY1, 10.PY2. For example, in applying the signal to a first field interaction device 10.X1, 10.X2, 10.Y1, 10.Y2 or field interaction pair 10.PX1, 10.PX2, 10.PY1, 10.PY2, the excitation signal S1 is output by at least one excitation device 10.1 in the form of an electromagnetic field or one or more electromagnetic waves. The excitation signal S1 is emitted from the first assembly 10 in the direction of the second assembly 20 and impinges on at least one and, for example, multiple second field interaction devices 20.1 to 20.n. The excitation signal S1 is modulated at the one or more second field interaction devices 20.1 to 20.n and emitted in the form of at least one received signal S2 from the second assembly 20 back to the first assembly 10 in the form of an electromagnetic field or one or more electromagnetic waves.

The received signal S2 is detected by at least one first field interaction device 10.X1, 10.X2, 10.Y1, 10.Y2 or field interaction pair 10.PX1, 10.PX2, 10.PY1, 10.PY2, and a signal evaluation is performed by the evaluation electronics 10.3.

The evaluation electronics 10.3 may include, for example, a microcontroller, an oscillating circuit, an ASIC, and multiple multiplexers.

The position values X1, X2, Y1, Y2 and distance values Z_X1, Z_X2, Z_Y1, Z_Y2 determined by the signal evaluation are used to determine the mean values, rotation values, and quality parameters described above.

For example, the modulation of the excitation signal S1 takes place within the second field interaction devices 20.1 to 20.n by eddy currents being formed.

For example, each second field interaction device 20.1 to 20.n is structurally configured in the same manner, and all second field interaction devices 20.1 to 20.n are arranged equidistantly from each other in a grid.

The position determination takes place within a predefined measuring range according to an absolute measuring method. The measuring range depends on the length of the first field interaction devices 10.X1, 10.X2, 10.Y1, 10.Y2; 10.X1′, 10.X1″, 10.X2′, 10.X2″, 10.Y1′, 10.Y1″, 10.Y2′, 10.Y2″ in the corresponding measurement direction x, y or on the resulting 0° and 90° signals.

At the start of the measurement, the first and second assemblies 10, 20 are oriented relative to each other in a defined manner within the measuring range, for example, by centering the first assembly 10 relative to the second assembly 20 (see, e.g., FIG. 6a). In response to a relative deflection of the first assembly 10 in relation to the second assembly 20, the absolute position of the first assembly within the measuring range may be determined.

For example, the area of the second interaction surface 21 is smaller than or equal to the area of the measuring range.

What is claimed is:

1. An inductive position measuring device, comprising:
a first assembly including a first interaction surface and multiple first field interaction devices arranged parallel to the first interaction surface, at least one of the first field interaction devices is arranged along a first measurement direction and at least one of the first field interaction device is arranged along a second measurement direction, each first field interaction device including at least one excitation device configured to generate an electromagnetic field and at least one receiver configured to receive an electromagnetic field; and
a second assembly including a second interaction surface and multiple second field interaction devices arranged in a flat manner distributed over the second interaction surface, the second assembly being arranged opposite the first assembly in a third measurement direction, the first assembly and the second assembly being movable relative to each other;
wherein the first and second field interaction devices are configured to be brought into electromagnetic interaction with each other.

2. The inductive position measuring device according to claim 1, wherein the first field interaction devices include elongated linear sensors, and the first and second measurement directions are perpendicular to each other.

3. The inductive position measuring device according to claim 1, wherein each first field interaction device includes:
a first receiver and a second receiver that have a periodic curve with a constant period length, the receivers being arranged offset from each other by a quarter of the period length in the first or second measurement direction; and
an excitation device that surrounds the first and second receivers.

4. The inductive position measuring device according claim 1, wherein the first assembly includes four first field interaction devices that are arranged in the first interaction surface and that are perpendicular to each other.

5. The inductive position measuring device according to claim 3, wherein the first assembly includes four first field interaction devices that are arranged in the first interaction surface and that are perpendicular to each other, and the receivers of the four first field interaction devices have a peak-to-peak amplitude that corresponds to at least one period length.

6. The inductive position measuring device according to claim 1, wherein the first assembly includes eight first field interaction devices that are arranged in the first interaction surface and in four pairs of parallel field interaction pairs that are arranged perpendicular to each other.

7. The inductive position measuring device according to claim 3, wherein the first assembly includes eight first field interaction devices that are arranged in the first interaction surface and in four pairs of parallel field interaction pairs that are arranged perpendicular to each other, the first receivers of at least one field interaction pair being identical and connected in series, the second receivers of at least one field interaction pair being identical and connected in series, the receivers of the field interaction pairs having a peak-to-peak amplitude that is less than half the period length, a distance between two receivers of at least one field interaction pair being half the period length.

8. The inductive position measuring device according to claim 1, wherein the second assembly is not connected to an active power supply device and data processing device.

9. The inductive position measuring device according to claim 1, wherein the second field interaction devices are arranged in a quadrangle or a square, are of equal size, and are arranged in a grid evenly distributed on the second interaction surface.

10. The inductive position measuring device according to claim 1, wherein the second field interaction devices are produced using planar technology, a thick-film technique, and/or a thin-film technique.

11. The inductive position measuring device according to claim 1, wherein the first, second, and third measurement directions are perpendicular to each other.

12. The inductive position measuring device according to claim 1, wherein the inductive position measuring device is adapted to determine a relative position between the first assembly and the second assembly in at least four degrees of freedom.

13. The inductive position measuring device according to claim 1, wherein the inductive position measuring device is adapted to determine a relative position between the first assembly and the second assembly in six degrees of freedom.

14. The inductive position measuring device according to claim 13, wherein the six degrees of freedom include position in three perpendicular axes and rotation about the three perpendicular axes, each of the three perpendicular axes corresponding to a respective one of the first, second, and third measurement direction.

15. A method for operating an inductive position measuring device as recited in claim 1, comprising:
transmitting a predetermined excitation signal to the second assembly using at least one of the first field interaction devices;
measuring separately a received signal present at at least one of the first field interaction devices;
determining linear position information and/or distance information of the at least one of the first field interaction devices based on signal evaluation of at least one received signal.

16. The method according to claim 15, wherein the inductive position measuring device determines relative position between the first assembly and the second assembly.

17. The method according to claim 15, further comprising determining at least one first quality parameter from position information between the first assembly and the second assembly and/or distance information of the first field interaction devices that determine the position information and/or the distance information with respect to a same one of the measurement directions.

18. The method according to claim 15, further comprising determining at least one rotation information about an axis oriented in one of the measurement directions from the position information and/or the distance information of the first field interaction devices.

19. The method according to claim 18, further comprising determining at least one second quality parameter from the at least one rotation information.

20. The method according to claim 15, further comprising:
determining at least one first quality parameter from position information between the first assembly and the second assembly and/or distance information of the first field interaction devices that determine the position information and/or the distance information with respect to a same one of the measurement directions;
determining at least one rotation information about an axis oriented in one of the measurement directions from the position information and/or the distance information of the first field interaction devices;
determining at least one second quality parameter from the at least one rotation information; and
outputting an error signal and/or performing an optimization method, based on the first quality parameter and/or the second quality parameter.
